(19) United States
(12) Patent Application Publication
(10) Pub. No.: US 2026/0247447 A1
(43) Pub. Date: Aug. 20, 2026

(54) CELLULAR NETWORKS

(71) Applicant: Inmarsat Global Limited, London, Greater London (GB)

(72) Inventors: Luca LODIGIANI, London, Greater London (GB); Raphaël IHAMOUINE, London, Greater London (GB)

(21) Appl. No.: 19/161,987

(22) PCT Filed: Mar. 4, 2024
(86) PCT No.: PCT/GB2024/050569

§ 371 Date: Sep. 3, 2025

(30) Foreign Application Priority Data
Mar. 3, 2023 (GB) 2303163.6

(51) Int. Cl. H04W 74/0833; H04W 64/00; H04W 74/08; H04W 84/06

(52) U.S. Cl. CPC H04W 74/0833; H04W 64/00; H04W 74/0891; H04W 84/06

(57) ABSTRACT

In a cellular telecommunications network, an out of band channel is used to provide a base station and/or user equipment with ranging or timing offset information to extend the RACK Preamble reception window and adjust Timing Advance (TA) and other timing relationships, thus allowing the extension of the cell range without requiring protocol changes or additional system information. There may be provided a plurality of concentric cells with different cell ranges.

### TECHNICAL FIELD

The present invention relates to cellular telecommunications networks and methods of operation therein, particularly but not exclusively for implementing cellular range extension.

### BACKGROUND ART

In terrestrial cellular networks, user equipment (UE) communicates wirelessly with a base station (BS) with coverage comprising one or more cells. The range within which a UE can communicate with a BS may be limited by the propagation delay of wireless signals transmitted between the UE and the base station.

For example, one of the channels in which a UE communicates with a BS may be a random access channel (RACH), which is a channel shared by multiple UE without predefined allocation of any part of the channel to any particular UE. The RACH is typically used by the UE to request access to services from the BS. As the RACH is shared between different UE, there is a risk of collision between transmissions from different UE.

One technique for reducing the probability of collisions in a RACH is to define time slots within the channel and to require UE to align their transmissions with the time slots. This requires the propagation delay between the UE and the BS to be estimated so that transmissions are synchronised to time slots as received at the BS. This may be achieved by defining a timing advance (TA) for each UE, which sets the timing offset that the UE applies to its transmissions. The range of possible values for the TA depends on the Random Access channel design, which then limits the range of distance between the UE and the BS within which access to the RACH is enabled, and hence the range of the cell.

In the 5G (fifth generation) New Radio (NR) standards, as of Release 17 (2022), the use of 5G NR in Frequency Range 2 (FR2) (i.e. above 24 GHz) is limited to a maximum range of about 5 km or less due to limitations of the RACH design, which limits the maximum cell radius within which the gNB (gNodeB e.g. a base station) can accurately estimate UE position and thus establish correct timing relationships including initial TA.

Existing methods for range extension, such as the Release 17 Non-Terrestrial Networks (NTN) standard, make use of additional system information within the protocol to provide UE with BS position, such as satellite position and trajectory in the form of satellite ephemeris, and require the protocol and UE to support receiving and decoding such system information. In some instances the UE may be required to determine its own location, for example using a Global Navigation Satellite System (GNSS).

Other methods assume a fixed offset in the form of BS distance, or satellite or HAPS altitude, which is always applied when allocating PRACH resources, due to a minimum distance from the BS that is common to all UEs and that is known in advance. Other methods make use of a specially-designed extended PRACH preamble.

Some range extensions for 5G NR mmWave (e.g. 20-300 GHz) have been demonstrated in the context of Fixed Wireless Access (FWA) but have been limited to up to about 7 to 9 km and generally assume that the UE and BS are both fixed.

### Statements of the Invention

Aspects of the invention are defined in the accompanying claims.

In at least some embodiments of the invention, an out of band communications channel is used to provide either the BS or the UE with UE or BS ranging or timing offset information respectively, to extend or shift the Random Access Channel (RACH) Preamble reception window at the BS and/or adjust the Timing Advance (TA) at the UE, as well as optionally adjusting other timing relationships, thus allowing the extension of the cell range without requiring protocol changes or additional system information transmitted in-band.

The out of band channel, which may also be referred to as a side channel or out-of-band connection, may comprise a channel in another network different from the cellular network in which the range extension policy is enforced. For example, where the range extension policy is applied in a terrestrial cellular network, the out of band channel may be a satellite network channel or a channel in any other network, whether terrestrial cellular or otherwise. The out of band channel may be a radio (e.g. wireless) or non-radio (e.g. wired) channel.

In contrast, an in-band channel or in-band connection comprises a radio protocol communication to be established between the BS and the UE(s) in a give frequency band.

In at least some embodiments, the ranging or timing offset information may be provided by an entity or node external to the cellular network in which the range extension policy is enforced. The external entity or node is logically separate from, and may or may not be physically separate from the BS.

Advantageously, in the context of 5G NR FR2 for example, embodiments of the invention may extend the range of a BS well beyond the maximum range supported by the standard (e.g. 10 km) in a way that is transparent to the 5G standard and is applicable to Time Division Duplex (TDD) as well as other duplexing methods.

At least some embodiments may be implemented in a system where both UE and BS can be either fixed or mobile.

In some embodiments UE and/or BS location, ranging or velocity vector information can be collected directly or indirectly from one or more UE or BS respectively via either in-band methods, or via out-of-band methods if preferred or when in-band methods are not available (e.g. where the in-band channel is not established or requires to be re-established). In other embodiments, information about UE and/or BS location, ranging or velocity vector may be available indirectly through external systems. An external entity then may use UE and/or BS location, ranging or velocity vector data to compute ranging between UE and BS on a near-real-time basis and derive ranging assistance or timing advance offset information, which may then be supplied to either the BS, UE or both via an out-of-band channel such as, but not limited to, via a satellite communications link.

In some embodiments, the application of a common timing offset at the BS may achieve effective range extension of the nominal cell maximum range, thereby also shifting the effective cell minimum range. In some instances, this may create a coverage hole between the actual physical position of the cell and the new effective cell minimum range resulting from the offset. The further elimination of this resulting coverage gap may be achieved by creating concentric cells with different offset ranges that may provide coverage at different non-overlapping, or minimally-overlapping, maximum and minimum ranges.

In some embodiments, the effective range extension of the nominal cell maximum range may be achieved by applying knowledge of the timing offset between BS and UE to vary the timing of the Random Access signal or preamble detection window in the BS.

In some instances, the knowledge of the timing offset may be insufficiently accurate to allow accurate detection of the Random Access signal or preamble, in which case the BS may apply multiple different offsets in turn to the Random Access signal or preamble detection window. For example, the timing of the preamble detection window may be adjusted until reliable detection is achieved. In some embodiments, an error margin of the ranging information provided to the BS may be used to determine the range of corrections to be applied in the Random Access preamble or signal detection window.

In some other embodiments, the effective range extension of the nominal cell maximum range may be achieved by applying knowledge of the timing offset between BS and UE to proactively advance or delay the transmission of the Random Access signal or preamble by the UE towards the BS. In some instances, the knowledge of the timing offset may be insufficiently accurate to allow a UE to determine the required offset to allow successful detection by the BS, in which case the UE may make multiple transmission attempts, with different timing offsets, until the transmission is acknowledged by the BS. In some embodiments, an error margin of the ranging information provided to the UE may be used to determine the range of corrections or variation to be applied in the Random Access preamble or signal transmission timing advance or delay offset.

### BRIEF DESCRIPTION OF THE DRAWINGS

Specific embodiments of the present invention will now be described with reference to the accompanying drawings listed below.

FIG. 1 is a diagram illustrating a cell arrangement in an embodiment.

FIG. 2 shows a protocol employed in a RACH channel in the embodiment.

FIG. 3 is a diagram illustrating a more specific embodiment.

FIG. 4 is a flowchart showing the operation of the embodiment of FIG. 3.

FIG. 5 is a more detailed flowchart showing a more detailed version of the method of FIG. 4.

FIG. 6 is a diagram of a cellular arrangement in an embodiment.

### DETAILED DESCRIPTION OF EMBODIMENTS

FIG. 1 shows an embodiment in a terrestrial network in which cellular coverage is provided by a BS 2 to one or more UEs 1, which may comprise mobile terminals or customer premises equipment (CPE), for example. The UEs 1 may be handheld or located within vehicles, such as ships or aircraft.

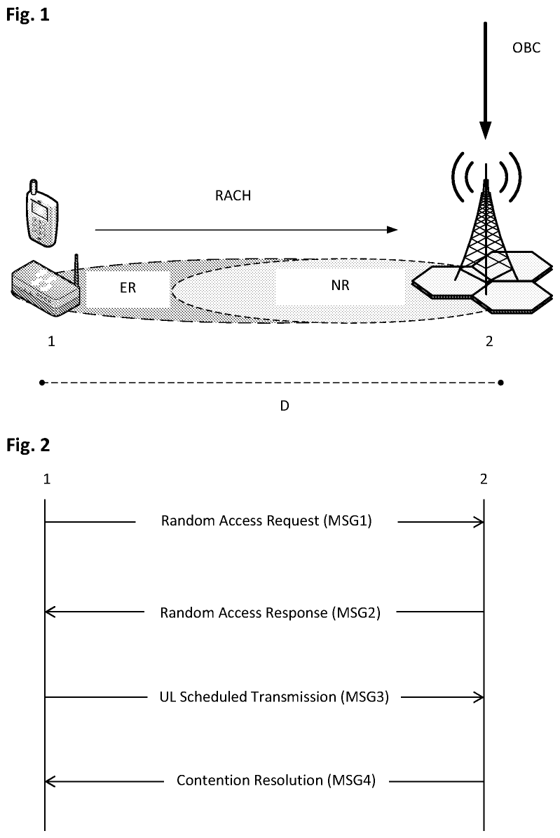

The UE 1 requests access to services from the BS 2 in a RACH channel, for example using a Random Access (RA) protocol shown in FIG. 2. The UE 1 transmits to the BS 2 a random access request message MSG1, comprising a contention-based preamble that identifies the UE 1. The BS 2 responds with a random access response message MSG2, comprising a detected identity (ID) of the UE 1 based on the received preamble, and a timing advance (TA) command. The UE 1 then transmits an uplink (UL) scheduled transmission message MSG3, with a timing offset determined by the TA command received from the BS 2. The third message MSG3 contains a contention resolution ID. If the BS 2 receives the third message MSG3 correctly, it responds in a fourth message MSG4 confirming the contention resolution ID. The UE 1 may then send a confirmation to the BS 2 in a physical uplink shared channel (PUSCH).

In the above RA protocol, both the BS 2 and the UE 1 set timers defining windows for receiving messages, and the timer(s) may expire due to a misaligned sub-frame (SF) index in the reception of the message(s). The range of permissible timing alignments between the BS 2 and UE 1 may determine the size of a cell, due for example to the propagation time due to the range between the BS 2 and the UE 1.

In the above protocol, the BS 2 needs an appropriate value of the timing advance (TA) to send to the UE 1, which value depends on the distance D between the UE 1 and the BS 2. In this embodiment, the BS 2 receives an out of band channel OBC containing information of the appropriate TA value for the specific UE 1, or at least information that allows the BS 2 to calculate the appropriate value. For example, the out of band channel OBC may include ranging information (i.e. relating to the distance D) or timing offset information relating to the specific UE 1.

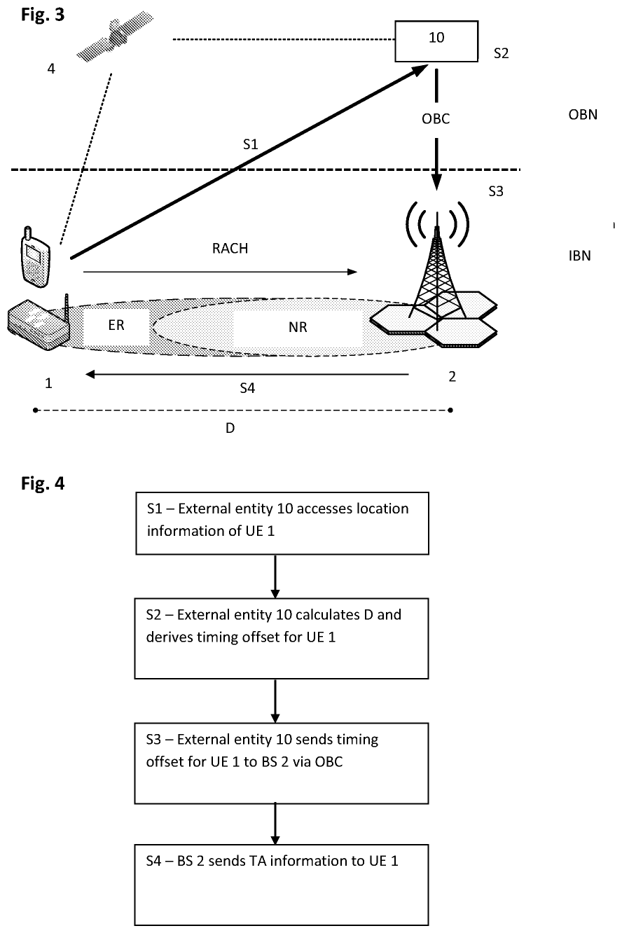

As shown in FIG. 3, the system in which embodiment of the invention operates may be divided into an in-band network (IBN), comprising UE 1, BS 2 and in-band channels for communication therebetween such as the RACH, and an out-of-band network (OBN) comprising the OBC and other network access nodes such as one or more satellites 4, in the case of a satellite network.

In at least some embodiments the out of band channel OBC comprises a satellite link provided by one or more satellites 4, in a channel provided by a satellite communications network to which the UE 1 has access. Hence in this embodiment the UE 1 may be a hybrid terminal or node that is able to communicate both with a terrestrial cellular network via the BS 2 and a satellite network via the satellite 4. The satellite link may be a low-rate satellite link, for example using an otherwise unallocated capacity within the satellite network.

Both the IBN and the OBN may be connected to an external entity 10, for example a network management node or core network node, which coordinates the operation of the satellite and terrestrial cellular networks.

One method of operation of the embodiment will now be described with reference to FIG. 4. At a first step S1, location information relating to the UE 1 is accessed by the external entity 10 via either in-band or out-of-band channels. For example, the UE 1 may periodically derive its location information, e.g. using GNSS, and transmit its location information to the external entity 10, via either an in-band or out of band channel.

At a second step S2, the external entity 10 then uses the UE location information to determine, or at least estimate, the distance or range D between the UE 1 and BS 2 and derive therefrom ranging assistance or timing advance offset information specific to the UE 1 and the BS 2.

At a third step S3, the external entity 10 then provides the ranging assistance or timing advance offset information to the BS 2 via the out of band channel OBC.

At a fourth step S4, the BS 2 sends ranging assistance or timing advance information to the UE 1, based on the ranging assistance or timing advance offset information provided to the BS 2 from the external entity 10. The timing information may be sent in the Random Access Response message MSG2 in the RA protocol described above with reference to FIG. 2.

In an alternative to the above method of operation, the external entity 10 may provide the ranging assistance or timing advance offset information directly to the UE1, for example via an OBC without routing through the BS 2.

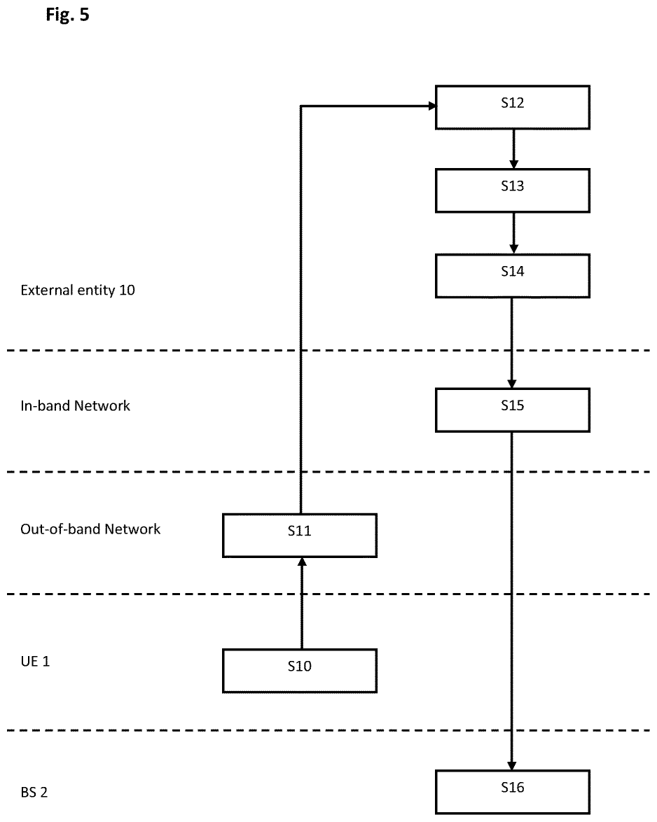

FIG. 5 is a diagram showing one version of the method of FIG. 4 in more detail. At Step S10, UE 1 sends information identifying its location, via the OBN (step S11), to the external entity 10. At step S12, the external entity 10 estimates the distance of the UE 1 from the BS 2, using for example information identifying the location of BS 2. At step S13, the external entity 10 calculates or otherwise determines the required timing offset for the UE 1 when communicating with the BS 2. At step S14, the external entity 10 enforces a radio performance enhancement policy relating to timing offset for BS 2.

At step S15, the external entity 10 transfers data identifying the radio performance enhancement policy via the IBN (or alternatively via the OBN) to the BS 2, which then performs radio communication with UE 1 with a timing offset determined by the radio performance enhancement policy (step S16).

In a variant of the above methods, it may not be possible for the UE 1 to determine its own location; for example, the UE 1 may lack a GNSS receiver or other means of location. Instead, the external entity 10 may determine the location of the UE 1 by information external to the UE 1 and/or not available to the UE 1. For example, where UE 1 is located on a vessel such as a ship or aircraft, the external entity 10 may access data associating the UE 1 with the vessel, and data identifying the current or expected location of the vessel. For example, the external entity may access vessel location or velocity tracking data, or route plan data indicating the expected location of the vessel at the current time.

Alternatively or additionally, the external entity 10 may derive the location of the UE 1 from signals from the UE 1, for example by obtaining information about the signal strength of transmissions from the UE 1 at different BS 2 in a cellular network.

Alternatively or additionally, the external entity 10 may derive the location of the UE 1 from mobility management information available to the OBN, for example information used for cell handover within the OBN and/or handover between the IBN and OBN.

The external entity 10 may determine the location of the BS 2 from location data provided either by the BS 2 or from other sources, such as a database of the locations of different base stations including BS 2 within a network. Where the BS 2 is mobile, the external entity 10 may determine the current location of the BS 2 from tracking or route plan information, similarly to the location of the UE 1 as described above.

The determined location of the UE 1 and/or the BS 2 may be subject to error, depending on the location method. In some cases, the degree of error is insignificant in terms of the timing offset e.g. the error does not materially affect the ability to receive transmissions within a specified timing window, or the timing advance setting. In other cases where the error may be significant, the degree of error may be included in the radio performance enhancement policy communicated to the BS 2. The BS 2 may then apply a variable timing of the timing window with a variation determined by the degree of error, until the correct timing is obtained and transmissions from the UE 1 are received within the timing window, or the UE 1 may apply a variable timing offset.

The timing advance offset information may include a common timing offset that is applied to all the UEs 1 within coverage of the BS 2, based on a minimum distance DMIN between the UEs 1 and the BS 2. The individual timing offset for each UE 1 may then added to the common timing offset.

The application of a common timing offset achieves effective range extension ER of the nominal cell maximum range NR, thereby also shifting the effective cell minimum range. The common timing offset and hence the range extension is effectively determined by the closest active UE 1 to the BS 2. In some embodiments in which individual timing offsets do not need to be determined, due for example to the size of the timing window in an RACH, only the location of the active UE 1 that is closest to the BS 2 need be tracked, together with periodic checks to determine which active UE 1 is closest to the BS 2, for example based on route plan data.

In other embodiments, only the active UI that is farthest from the BS 2 may need to be tracked; for example the common timing offset may be determined with reference to the farthest UE 1 from the BS 2, with individual timing offsets being subtracted from the common timing offset.

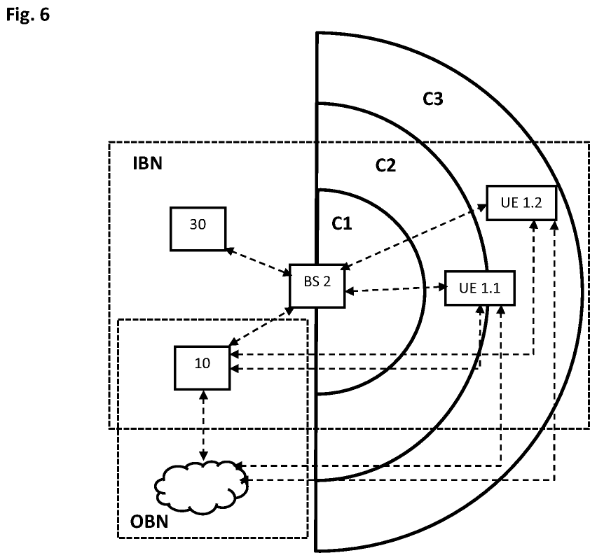

The application of a common timing offset may shift the effective cell minimum range. This may create a coverage gap in the area less than the minimum distance DMIN from the BS 2. The coverage gap may be reduced or eliminated by creating a plurality of circular or annular cells concentric with the BS 2, as shown for example in FIG. 6. In this Figure, the cells C1, C2, C3 are shown as semi-circular for convenience; in practice, the shape of the cells will be determined by the beam pattern and/or physical constraints. Each concentric cell may be managed by a corresponding remote radio unit (RRU), which may be connected to a common gNB (e.g. BS 2).

Each cell C1, C2, C3 has a minimum radius defined by the common timing offset for that cell, and a maximum radius defined by the maximum timing offset relative to the common timing offset, the maximum timing offset being determined by RACH channel constraints as discussed above. This may be achieved by defining within the RF policy a tuple for each UE 1, comprising the timing offset and the physical cell ID.

Preferably, the concentric cells are defined so as have minimal overlap. In some cases, the implementation of concentric cells may result in interference between the cells C1, C2, C3, particularly between adjacent ones of the cells. This interference may be mitigated using known techniques.

FIG. 6 shows UE 1.1 at the boundary between cells C2 and C3, and UE 1.2 within cell C3. Handover of UEs between the cells C1, C2 and C3 may be performed using known handover techniques.

FIG. 6 also shows the connectivity between BS 2 and UE 1.1 and UE 1.2 within the IBN, and connectivity between the external entity 10 and UE 1.1 and UE 1.2 within the OBN. BS 2 may also communicate with the external entity 10 via the OBN. BS 2 is connected to core network 30 within the IBN.

The above embodiments are described with reference to 5G NR standards, but the present invention is not limited to the use of those standards.

1. A method of operation of a cellular communications network comprising user equipment (UE) in communication with a base station (BS), the method comprising:
obtaining, at an entity external to the network, location information relating to the UE;
deriving, at the external entity, ranging and/or timing offset information relating to the UE relative to the BS;
providing the ranging and/or timing offset information to the BS and/or to the UE; and
applying a timing offset to random access transmissions between the UE and the BS, based on the ranging or timing offset information.

2. The method of claim 1, wherein the ranging or timing offset information is provided to the BS via an out-of-band channel (OBC).

3. The method of claim 2, wherein the BS comprises a terrestrial base station and the out-of-band channel comprises a satellite link.

4. The method of claim 1, wherein the timing offset is applied to a transmission from the UE to the BS.

5. The method of claim 1, wherein the timing offset is applied to a reception window at the BS for reception of a transmission by the UE.

6. The method of claim 1, wherein the UE derives its location information and transmits the location information to the external entity.

7. The method of claim 1, wherein the external entity derives the location information relating to the UE.

8. The method of claim 6, including determining error range information relating to the location information, and providing the error range information together with the ranging and/or timing offset information.

9. The method of claim 8, wherein the applied timing offset is variable in dependence on the error range information.

10. The method of claim 1, wherein there are a plurality of UE in communication with the BS, and the BS derives a common timing offset for transmissions between the UE and the BS.

11. The method of claim 10, wherein the BS derives individual timing offsets for the respective UE, relative to the common timing offset.

12. The method of claim 10, wherein the common timing offset determines a minimum range of a cell provided by the BS.

13. The method of claim 12, wherein a plurality of cells are defined with different minimum cell ranges, each cell having a respective common timing offset for UE within that cell.

14. (canceled)

15. The method of claim 1, wherein the network comprises a 5G NR network.

16. A cellular communications system, comprising user equipment in communication with a base station and an external entity arranged to:
obtain location information relating to the UE;
derive ranging or timing offset information relating to the UE relative to the BS; and
provide the ranging or timing offset information to the BS and/or to the UE;
wherein a timing offset is applied to random access transmissions between the user equipment and the base station, based on the ranging or timing offset information.

17. (canceled)

18. The system of claim 16, wherein the ranging or timing offset information is provided to the BS via an out-of-band channel (OBC).

19. The system of claim 16, wherein the external entity is arranged to determine error range information relating to the location information, and to provide the error range information together with the ranging and/or timing offset information.

20. The system of claim 19, wherein the applied timing offset is variable in dependence on the error range information.
